(19) United States
(12) Patent Application Publication
(10) Pub. No.: US 2014/0278766 A1
(43) Pub. Date: Sep. 18, 2014

(54) METHODS AND APPARATUS FOR PROVIDING APPLICATION PROVISIONING

(71) Applicants: Gil Dudkiewicz, New York, NY (US); Ran Avidan, Zichron Yaakov (IL)

(72) Inventors: Gil Dudkiewicz, New York, NY (US); Ran Avidan, Zichron Yaakov (IL)

(21) Appl. No.: 14/218,458

(22) Filed: Mar. 18, 2014

Related U.S. Application Data
(63) Continuation of application No. PCT/US14/16063, filed on Feb. 12, 2014.
(60) Provisional application No. 61/763,715, filed on Feb. 12, 2013.

(51) Int. Cl. G06Q 30/02; H04L 12/771

(52) U.S. Cl. CPC G06Q 30/0201; H04L 45/563
USPC 705/7.29

(57) ABSTRACT

Methods and Apparatus are described herein for providing a provisioning platform on an electronic device. In some embodiments, a method includes receiving from an electronic device a request to download an access application. A code that is configured to cause the access application to be installed on the electronic device is sent to the electronic device. The access application is configured to provide a dynamic access point on a display of the electronic device. When selected by a user of the electronic device, the dynamic access point provides access to at least one of a website, an application previously downloaded on the electronic device, or an application store within the access application.

### CROSS-REFERENCE TO RELATED APPLICATIONS

This application is a continuation of International Application No. PCT/US14/16063, filed Feb. 12, 2014, which claims priority to and the benefit of U.S. Provisional Patent App. Ser. No. 61/763,715, entitled “Methods and Apparatus for Providing Application Provisioning,” filed Feb. 12, 2013, the disclosures of which are incorporated herein by reference in their entirety.

### BACKGROUND

Some embodiments described herein relate generally to electronic devices that can communicate within a communication network using a web browser, and more particularly, to electronic devices such as, for example, computers, mobile devices, etc., servers and/or systems providing enhanced functionality such as a software development kit (e.g., mobile application development kit) for application provisioning.

Online service providers are continually challenged to deliver value and convenience to consumers by, for example, providing compelling applications to help the consumers perform various tasks using electronic devices. In recent years, with the wide spread and growing popularity of electronic devices, application development has received much attention. Specifically, free mobile applications have become popular among mobile device users, where the user can download and use the application free of charge. Currently, the developers of free applications may earn revenue though options such as incorporating advertisements and market access links into these applications. There are, however, no known out-of-application monetization channels that can facilitate revenue monitoring for application providers, while monitoring users' response to the advertisements. Therefore, a platform for provisioning (distribution, usage tracking, etc.) of various applications is needed to manage and monitor application presentation on electronic devices, while provisioning the effect of advertisements, and application developers' revenue, accordingly.

### SUMMARY

Methods and apparatus are described herein for providing a provisioning platform on an electronic device. In some embodiments, a method includes receiving from an electronic device a request to download an access application. A code that is configured to cause the access application to be installed on the electronic device is sent to the electronic device. The access application is configured to provide a dynamic access point on a display of the electronic device. When selected by a user of the electronic device, the dynamic access point provides access to at least one of a website, an application previously downloaded on the electronic device, or an application store within the access application.

### BRIEF DESCRIPTION OF THE DRAWINGS

FIG. 1 is a schematic block diagram of a computer network system in which application provisioning functions can be provided by an embedded provisioning platform, according to an embodiment.

FIG. 2A is a schematic illustration of an application provider device and a user electronic device (UE), according to an embodiment.

FIG. 2B is a schematic illustration of a provisioning platform, according to an embodiment.

FIG. 2C is a schematic illustration of a dynamic access point, according to an embodiment.

FIG. 3 is a flowchart of a process for providing dynamic access points via applications associated with an embedded provisioning platform, according to an embodiment.

FIG. 4 is a schematic block diagram of a computer network system in which application provisioning functions can be provided by a non-embedded provisioning platform, according to an embodiment.

FIG. 5 is a schematic illustration of a non-embedded provisioning platform, according to an embodiment.

FIG. 6 is a flowchart of a process for providing dynamic access points via applications associated with a non-embedded provisioning platform, according to an embodiment.

FIG. 7 is a flowchart illustrating a method of providing a software development kit for developing access application, according to an embodiment.

### DETAILED DESCRIPTION

Current known technology can enable service providers to provide platforms for offering various services to users of electronic devices via applications that can be downloaded from application provider devices and installed or downloaded on the electronic devices. Many application providers commonly offer their services (e.g., applications) to the users free of charge hoping to gain revenue indirectly through strategies such as, for example, incorporating advertisements in their offered applications; promoting other applications, products or websites; providing various offers to the users; etc. Systems and methods, however, are needed for providing control and monitoring of revenue for application providers. Furthermore, the current strategies may distract users and result in undesirable user experiences. Therefore, a platform for provisioning, distribution, and tracking of various applications is needed to manage and monitor application presentation on electronic devices by providing dynamic access points (e.g., dynamic icons), such that the dynamic access points enable provisioning of effects of advertisements and application developers' revenue, accordingly.

Apparatus, systems and methods are described herein for providing a provisioning platform (also referred to herein as “access application”) to electronic devices that can provide dynamic application access points (e.g., dynamic icons) to the electronic devices and enable tracking of application usage by the electronic devices. In some embodiments, a method includes receiving from an electronic device a request to download an access application. A code that is configured to cause the access application to be installed on the electronic device is sent to the electronic device. The access application is configured to provide a dynamic access point on a display of the electronic device. When selected by a user of the electronic device, the dynamic access point provides access to at least one of a website, an application previously downloaded on the electronic device, or an application store within the access application

In some embodiments, a method includes sending, to a compute device from an electronic device, a request for an access application. A code configured to cause the access application program to be installed on the electronic device is received at the electronic device from the server. The access application is configured to provide a dynamic access point on a display of the electronic device. When selected by a user of the electronic device, the dynamic access point provides access to at least one of a website, an application previously downloaded on the electronic device, or an application store within the access application.

In some embodiments, a method includes receiving from an electronic device a request to download a software development kit. The software development kit includes (1) code to control display of content on the electronic device when an application developed by the software development kit is installed on the electronic device, and (2) code to provide a dynamic access point on a display of the electronic device such that, when selected by a user of the electronic device, the dynamic access point provides access to the content including at least one of a website, an application previously downloaded on the electronic device, or an application store within the application. The method further includes sending to the electronic device, the software development kit in response to the request to download.

In some embodiments, a provisioning platform (also referred to herein as “access application”) as described herein can provide monetization and distribution services for applications (e.g., free applications) provided by an application provider device (e.g., a server) for use on one or more electronic devices. The provisioning platform may also provide support for usage monetization by the application provider.

In some cases, application providers for electronic devices such as, for example, Android® mobile devices, may not be generating real revenues from their applications. Current monetization options such as, for example, in-application advertisement or freemium (a business model by which a product or service is provided free of charge, but a premium is charged for advanced features, functionality, or virtual goods) may result in a bad user experience (e.g., viewing ads while using an application) and still fail to provide any substantial revenue for the application provider. The provisioning platform can enable an application provider to provide application(s) capable of tracking usage and generating revenue, while improving the experience of their end users.

As used herein, the singular forms “a,” “an” and “the” include plural referents unless the context clearly dictates otherwise. Thus, for example, the term “a “dynamic access point” is intended to mean a single dynamic access point or a combination of dynamic access points (e.g., icons associated with a series of applications, services, websites, Internet pages, etc.).

FIG. 1 is a schematic block diagram of a computer network system in which application provisioning functions can be provided by an embedded platform, according to an embodiment. A computer network system 100 can include one or more user electronic devices or User Equipments (UEs) 101a-101n, each of which can be equipped with at least a User Interface (UI) 107a-107n; and one or more application provider devices (e.g., servers) 109a-109m each of which can be equipped with at least one embedded provisioning platform 103. As described herein, the UEs 101a-101n may also each be equipped with at least one embedded provisioning platform 103 (also referred to herein as an “access application”). For example, a UE can send a request to an application provider device to download a provisioning platform 103 on to the UE.

The application provider devices 109a-109m can be operatively coupled to each other via a communication network 105. Any of the devices or platforms of the network system 100 can be equipped with local memory/storage spaces (not shown in FIG. 1). Furthermore, the devices and platforms of the network system 100 may have access to centralized or distributed memory/storage spaces (not shown in FIG. 1) through the communication network 105. Thus, FIG. 1 is merely an example illustrating the types of devices and platforms that can be included within a computer network system 100.

Communication network 105 can be any communication network, such as the Internet, configurable to allow the one or more UEs 101a-101n, and the one or more application provider devices 109a-109m to communicate with communication network 105 and/or to each other through communication network 105. Communication network 105 can be any network or combination of networks capable of transmitting information (e.g., data and/or signals) and can include, for example, a telephone network, an Ethernet network, a fiber-optic network, a wireless network, and/or a cellular network.

In some instances, communication network 105 can include multiple networks operatively coupled to one another by, for example, network bridges, routers, switches and/or gateways. For example, the UEs 101a-101n can be operatively coupled to a cellular network; the application provider devices 109a-109m can be operatively coupled to a fiber-optic network. The cellular network and fiber-optic network can each be operatively coupled to one another via one or more network bridges, routers, switches, and/or gateways such that the cellular network, the Ethernet network and the fiber-optic network are operatively coupled to form a communication network. Alternatively, the cellular network and fiber-optic network can each be operatively coupled to one another via one or more additional networks. For example, the cellular network and the fiber-optic network can each be operatively coupled to the Internet such that the cellular network, the fiber-optic network and the Internet are operatively coupled to form a communication network.

As illustrated in FIG. 1, UEs 101a-101n can be operatively coupled to communication network 105 via network connection(s) 111; and application provider devices 109a-109m can be operatively coupled to communication network 105 via network connection(s) 113. Network connections 111 and 113 can be any appropriate network connection for operatively coupling UEs 101a-101n, and the application provider devices 109a-109m to the communications network 105.

A network connection can be a wireless network connection such as, for example, a wireless fidelity (“Wi-Fi”) or wireless local area network (“WLAN”) connection, a wireless wide area network (“WWAN”) connection, and/or a cellular connection. A network connection can be a wired connection such as, for example, an Ethernet connection, a digital subscription line (“DSL”) connection, a broadband coaxial connection, and/or a fiber-optic connection.

As mentioned above, in some instances, a computer network system 100 can include more than one UE 101a-101n, and more than one application provider device 109a-109m. A UE 101a-101n, and/or an application provider device 109a-109m (e.g., a server), can be operatively coupled to the communication network 105 by heterogeneous network connections. For example, a first UE 101a-101n can be operatively coupled to the communication network 105 by a WWAN network connection, another UE 101a-101n can be operatively coupled to the communication network 105 by a DSL network connection, and an application provider device 109a-109m can be operatively coupled to the communication network 105 by a fiber-optic network connection.

The application provider devices 109a-109m each can be, for example, a web server configured to provide various applications to electronic devices, such as UEs 101a-101n. For example, the UEs 101a-101n can be in communication with one or more of the application provider devices 109a-109m via the communication network 105.

The UEs 101a-101n can be any of a variety of electronic devices that can be operatively coupled to communication network 105. A UE 101a-101n can be a personal computer, a tablet computer, a personal digital assistant (PDA), a cellular telephone, a portable/mobile internet device and/or some other electronic communication device. A UE 101a-101n can also be a television set, a streamer device, a set top box, or any other electronic device equipped with a display unit (a UI 107a-107n) and a network connection 111 that enables the device to run applications on an operating system. The UEs 101a-101n each can include a web browser configured to access a webpage or website hosted on or accessible via the application provider devices 109a-109m over communication network 105. The UEs 101a-101n can be configured to support, for example, HTML using JavaScript. For example, the UEs 101a-101n can include a web browser, such as, Firefox, Safari, Dolphin, Opera and Chrome. An Internet page or website can be accessed by a user of a web browser at a UE 101a-101n by providing the web browser with a reference such as a uniform resource locator (URL), for example, of a webpage. For example, a user of a UE 101a-101n can access an application provider device 109a-109m via a URL designated for the application provider device 109a-109m. In some instances, UEs 101a-101n each can include specialized software for accessing a web server other than a browser, such as, for example, a specialized network-enabled application or program. In some instances, portions of a website accessible via a web server can be located in a local or remote memory space/data store accessible to the web server. A data store can be at least one of a database, a data warehouse, or a file. A UE 101a-101n can also include a display, monitor or user interface (UI) 107a-107n, a keyboard, various ports (e.g., a USB port), and other user interface features, such as, for example, touch screen controls, audio components, and/or video components (each not shown). A UE 101a-101n can be operatively coupled to communication network 105 via the UI 107a-107n and network connection 111.

Note that a UE 101a-101n can be used by an application developer user for providing applications that are offered to users of UEs 101a-101n by the application provider devices 109a-109n. Alternatively/additionally, a UE 101a-101n can be used by a user for accessing and using the applications developed by the developer and offered by the application provider devices 109a-109n.

As described in more detail herein, in some embodiments an application provider device 109a-109m can provide to a UE 101a-101n a provisioning platform 103. For example, a UE can send a request to an application provider device to download a provisioning platform 103. The provisioning platform 103 can thus be downloaded onto the UE and provide a dynamic access point icon (not shown in FIG. 1) (also referred to herein as “dynamic access point”) viewable on a display of the UE. Such an embodiment of a provisioning platform is also referred to herein as an embedded provisioning platform 103. The provisioning platform 103 can control the dynamic access point displayed on the UE as described in more detail below. The dynamic access point when selected by a user can, for example, direct the user to multiple different destinations, such as, to a selected website, and/or to an existing application on the UE, and/or to open or provide access to an applications store embedded within the provisioning platform 103 and downloaded on the UE. The application store can provide access to new applications that the UE can select and download onto the UE.

In some embodiments, an application provider device 109a-109m can provide to one or more UEs 101a-101n a software development kit (SDK) that can be downloaded on the one or more UEs 101a-101n. In some embodiments, an application provider vice 109a-109m can provide to one or more third party electronic devices (not show in FIG. 1), e.g., an application developer device, a software development kit (SDK) that can allow the third party to develop or create a provisioning platform as described herein which can then be provided by the third party electronic device to one or more UEs 101a-101n. The SDK can allow a provisioning platform 103 as described herein to be built or created on the one or more UEs 101a-101n. Such embodiments of a provisioning platform are also referred to herein as a non-embedded provisioning platform.

FIG. 2A is a schematic illustration of an application provider device 209 in communication with a UE 201 via a connection 215; and FIG. 2B is a schematic illustration of an embedded provisioning platform (also referred to herein as “access application”), according to an embodiment. Provisioning platform 203 can include components, features and functions the same as or similar to the provisioning platform 103 described above with reference to FIG. 1. As described above, the provisioning platform 203 and its components can be provided (e.g., downloaded) from the application provider device 209 to the UE 201 via a connection 217 within a communication network system, such as communication network system 100 described above.

As shown in FIG. 2B, the provisioning platform 203 can include a usage tracking module 210, an access control module 212, and a data store 214. The provisioning platform 203 can communicate with other components of a computer network system (e.g. computer network system 100 of FIG. 1) via input signal 216 and output signal 218.

As used herein, a module can be, for example, any assembly and/or set of operatively-coupled electrical components, and can include, for example, a memory, a processor, electrical traces, optical connectors, software (executing or to be executed in hardware) and/or the like. Furthermore, a module can be capable of performing one or more specific functions associated with the module, as discussed further below.

In various instances, the provisioning platform 203 and its components may be located anywhere within a communication network system, such as the communication network system 100 shown in FIG. 1. For example, the provisioning platform 203 can be located within the UEs 101a-101n, within the application provider devices 109a-109m, or in separate locations (e.g., third party servers or computing devices) within the communication network system 100 of FIG. 1.

As described above, the provisioning platform 203 can provide one or more dynamic access points 240 (also referred to herein as dynamic icon(s)) (see FIG. 2C) viewable on a display (not shown) of a UE. A dynamic access point 240 can, for example, direct a user to a selected website 242, and/or to an existing application 244 on the UE, and/or open or provide access to an app store 246 embedded within the provisioning platform 203. The app store 246 can provide access to new applications that the UE can select and download onto the UE.

The appearance of the dynamic access point 240 can be provided and/or modified based on information such as, for example, a profile of a user of the UE 201, usage patterns of the UE 201, etc. For example, a dynamic access point 240 that can provide a link or access to an application A can be presented to a user with a shape, color, and/or presentation of the dynamic icon being based, on user profile aspects such as, for example, a user's age, user's personal interests, user's recent activities, user's location, etc.

The usage tracking module 210 can track and store information associated with usage of the UE 201, including, for example, a usage pattern of the application A on the UE 201. For example, the usage tracking module 210 can store the collected tracking data in data store 214. The access control module 212 can control the operation and function of the access point 240. The access control module 214 can also control the presentation of or interaction with one or more websites accessed by the UE 201 via the access point 240. For example, when an application A, provided to the UE 201 by the application provider device 209 is installed or downloaded on the UE 201, the access control module 212 can control presentation of or interaction with one or more websites accessed by the UE 201 associated with the application A. The access control module 203 may also enable a developer (e.g., via a third party computing device) to provide applications provided by the third party developer via the access application such that when installed on the UE 201 the access application can provide a dynamic access point associated with the application provided by the third party developer on the UE 201.

The dynamic access point 240 can be, for example, a graphic image (e.g., an icon), a picture or an object that can provide a link or shortcut to access various programs, applications, websites, etc. as described above. As described above, dynamic access point 240 can be an access point (e.g., an icon) having features such as shape, color, location, etc. that can be changed or modified based on information such as a user profile, a user's usage pattern of, for example, an application A, accessed via the dynamic access point 240, etc. Furthermore, as described above, the dynamic access point can provide a link to an embedded application store that can enable the user to download new applications. The access control module 212 can control presentation of or interaction with a website on the UE 201, for example, through controlling access to the website by a user of the UE 201. The access control module 212 can also control a destination (e.g., a website) accessed by the UE 201 via the dynamic access point 240. Each of the modules 210 and 212 can store input, output or process data on their local memory spaces, or on or within the data store 214.

Note that the UE 201 can be used by an application developer (e.g., via a third party computing device) for providing applications that are offered to a user of UE 201 via the application provider devices 209. Alternatively/additionally, the UE 201 can be used by a user for accessing and using the applications developed by the application developer and offered by the application provider device 209.

An example process of providing a provisioning platform, such as, for example, provisioning platform 203, to a UE, such as UE 201, and displaying a dynamic access point (e.g., 240) provided by and controlled by the provisioning platform 203, is further described below in connection with the flowchart of FIG. 3.

FIG. 3 is a flowchart of a process for providing one or more dynamic access points via tan embedded provisioning platform, according to an embodiment. FIG. 3 is described with reference to provisioning platform 203, the UE 201 and application provider device 209.

At 320, a provisioning platform 203 at the application provider device 209 receives a request from the UE 201 via an input signal 216, to download an application P1 from the application provider device 209. The application P1 can include the provisioning platform 203 (i.e., access application) embedded therein. In some instances, the provisioning platform 203 enables the application provider device 209 to provide within the application P1, embedded information (e.g., a help file) or explanations to the users of the application P1 about features that are included within the application P1 (e.g., icons, usage tracking, etc.) via the UE 209. The applications provided by the application provider device 209 and their associated data such as, for example, the number of application downloads by users, can be collected by the provisioning platform 203 and stored locally at a memory of the application provider device 209, at a remote storage location accessible by the application provider device 209, or at the data store within the provisioning platform 203 at the application provider deice 209.

At 322, the access control module at the application provider device 209 can send a code C1 to the UE 201, which is configured to control display of content of a website, such that the application P1 is installed on the UE 201. The code C1 can also include code C2 to provide at least one dynamic access point on a display of the UE 201, which is associated with the application P1.

If, at 324, the application P1 is launched on the UE 201, then at 326, the provisioning platform 203 at the application provider device can send a command to the UE 201 via an output signal 216 to activate a code C3 at the UE 201. The code C3 can be configured to cause an access control module 212 within the application P1 at the UE 201 to control presentation of or interaction with a selected destination website on the UE 201. For example, the code C3 can be configured to enable the application P1 to control presentation of or interaction with a search engine on the UE 201 where controlling presentation of or interaction with the search engine can enable the usage tracking module 210 of the application P1 on the UE 201 to track usage of the search engine by the UE 201 via application P1. For example, the code C3 can collect data related to presentation of or interaction with a website on UE 201 via application P1. The collected data can be, for example, the number of interactions during a given time period, the duration of each interaction, a user profile (including location, age, interests, etc.), etc. The code C3 can store the collected data on the data store 214 within the application P1 at the UE 201 and/or send the collected data to the provisioning platform 203 at the application provider device 201. The usage tracking module 210 (at either or both the UE 201 or the application provider device 209) can analyze the received data for determining usage patterns of the website by the UE 201. Furthermore, the application P1 can use the data collected by the code C3 to control a selected destination (e.g., a selected website address) by a user of the UE 201.

The applications provided by the application provider device 209 and their associated data such as, for example, the number of application downloads by users, can be collected by the provisioning platform 203 and stored locally at a memory of the application provider device 209, at a remote storage location accessible by the application provider device 109a-109m, or at the data store 205, by the provisioning platform 200.

At 328, the access control module 212 can provide a shortcut to the selected destination on the UE 201, when at least one of the dynamic access points provided at step 322 on the UE 201 is selected by a user of the UE 21. The shortcut enables UE 201 to provide access to a user when the user selects the at least one dynamic access point.

Furthermore, the usage tracking data collected by the usage tracking module 210 may be stored at data store 214. The usage tracking data can be used for monetization purposes such that, for example, a developer of application P1 using a UE 101a-101n, can receive revenues based on the usage of the provided destinations by the same or other UEs 101a-101n via application P1.

In some embodiments, an application developer can open an account associated with the provisioning platform 203 and register their developed applications through the account. In some embodiments, an application developer can select a desired type of icon integration to be used as a dynamic access point on a UE 201 at the time of application download. For example, the provisioning platform 203 at the UE 201 can provide home screen icons, bookmark links, browser homepages, etc. on the UE 201 associated with that developer's application. The icons selected by the developer can be configured by the provisioning platform 203 and the dynamic access point(s) can be provided via the developer's application. Each selection and entry by the developer can be represented by a signal received by the provisioning platform 203 via input signal 216. Later, at the time of application download by a user of UE 201, the configured dynamic access point(s) are used by the provisioning platform 203 for displaying dynamic icons on a UI (e.g., similar to UI 107a-107n discussed above) of the UE 201 associated with the user.

After an application is registered by the developer at the provisioning platform 203 (e.g., at the application provider device 209), the provisioning platform 203 can provide an integrated dynamic access point(s) (e.g., dynamic icons) displayed on the UI associated with UE 201. The provisioning platform 203 can also track downloads of the developer's application at the UE 201 and collect and store download and usage data in a local memory of the application provider device 209, at a remote storage location accessible by the application provider device 209, or in the data store 214, as described above. This data can be provided to the developer to track usage and/or develop a revenue stream based on usage.

In some instances, the provisioning platform 203 can provide payment information to the developer based on the information entered by the developer and collected by the provisioning platform 203 from the application provider device 209. The developer can have a development management platform included within a provisioning platform at a developer's device (see, e.g., developer device 419 in FIG. 4 and discussed below). The development management platform can store the collected information at a local memory of the developer's device, or the information can be collected and stored at a local memory of the application provider device 209, at a remote storage location accessible by the application provider device 209, or at the data store 214 within the application provider device 209.

FIG. 4 is a schematic block diagram of a computer network system in which application provisioning functions can be provided by a non-embedded platform, according to an embodiment. A computer network system 400 can include one or more user electronic devices or User Equipments (UEs) 401a-401n, each of which can be equipped with at least a User Interface (UI) 407a-407n; one or more application developer devices 419; and one or more application provider devices (e.g., servers) 409a-409m; each of which can be operatively coupled to each other via a communication network 405. As shown in FIG. 4, any of the UEs 401, application developer devices 419 and the application provider devices 409 can include a provisioning platform 403. Any of the devices or platforms of the network system 400 can be equipped with local memory/storage spaces (not shown in FIG. 4). Furthermore, the devices and platforms of the network system 400 may have access to centralized or distributed memory/storage spaces (not shown in FIG. 4) through the communication network 405. Thus, FIG. 4 is merely an example illustrating the types of devices and platforms that can be included within a computer network system 400. Communication network 405 can be similar to the communication network 105 of FIG. 1.

As illustrated in FIG. 4, UEs 401a-401n are operatively coupled to communication network 405 via network connection(s) 411; application provider devices 409a-409m are operatively coupled to communication network 405 via network connection(s) 413; and the application developer devices 419 are operatively coupled to communication network 405 via network connection(s) 415. Network connections 411, 413, and 415 can be any appropriate network connection for operatively coupling UEs 401a-401n, application provider devices 409a-409m, and the application developer devices 419. The network connections 411, 413, and 415 can be similar to the network connections of FIG. 1

As mentioned above, in some instances, a computer network system 400 can include more than one UE 401a-401n, more than one application developer devices 419, and more than one application provider device 409a-409m. A UE 401a-401n, an application developer device 419, and/or an application provider device 409a-409m, can be operatively coupled to the communication network 405 by heterogeneous network connections. For example, a first UE 401a-401n can be operatively coupled to the communication network 405 by a WWAN network connection, another UE 401a-401n can be operatively coupled to the communication network 405 by a DSL network connection, and an application developer device 419 can be operatively coupled to the communication network 405 by a fiber-optic network connection.

The application provider devices 409a-409m each can be, for example, a web server configured to provide various applications to electronic devices, such as UEs 401a-401n. For example, the UE 401a-401n can be in communication with the application provider devices 409a-409m via the communication network 405 under the supervision of the provisioning platform 403.

The UEs 401a-401n can be any of a variety of electronic devices that can be operatively coupled to communication network 405. The UEs 401a-401n can be similar to the UEs 101a-101n of FIG. 1. An Internet page or website can be accessed by a user of a web browser at a UE 401a-401n by providing the web browser with a reference such as a uniform resource locator (URL), for example, of a webpage. For example, a user of a UE 401a-401n can access an application provider device 409a-409m via a URL designated for the application provider device 409a-409m. In some instances, UEs 401a-401n each can include specialized software for accessing a web server other than a browser, such as, for example, a specialized network-enabled application or program. In some instances, portions of a website accessible via a web server can be located in a local or remote memory space/data store accessible to the web server. A data store can be at least one of a database, a data warehouse, or a file. A UE 401a-401n can also include a display, monitor or user interface (UI) 407a-407n, a keyboard, various ports (e.g., a USB port), and other user interface features, such as, for example, touch screen controls, audio components, and/or video components (each not shown). A UE 401a-401n can be operatively coupled to communication network 405 via the UI 407a-407n and network connection 411.

FIG. 5 is a schematic illustration of a non-embedded provisioning platform, according to an embodiment. Provisioning platform 503 can be similar to the provisioning platforms 103, 203 described above. As shown in FIG. 5, a provisioning platform 503 can include a usage tracking module 510, a SDK module 521, an access control module 512 and a data store 514. Furthermore, the provisioning platform 503 communicates with other components of a computer network system (e.g. computer network system 400 of FIG. 4) via input signal 516 and output signal 518.

In various instances, the provisioning platform 503 and its components may be located anywhere within a communication network system (such as communication network system 400 shown in FIG. 4) including, but not limited to, within the UEs 401a-401n, within the application provider devices 409a-409m, or in separate locations within the communication network system 400 of FIG. 4. For example, the provisioning platform 503 can be located at one or more application developer devices 419.

The provisioning platform 503 can provide dynamic access points (e.g., dynamic icons), such as access point 240 described above, to applications on a UE 401a-401n, based on information such as, for example, a user profile of a user of the UE 401a-401n, usage patterns of UE 401a-401n by a user, etc. For example, a dynamic access point associated with an application A can be presented to a user as a dynamic icon where the shape, color, and presentation of the dynamic icon is based, at least, in part, on a user's age, a user's personal interests, a user's recent activities, a user's location, etc. The usage tracking module 510 tracks usage of the UE 401a-401n, including usage patterns of the application A on the UE 401a-401n. The usage tracking module 510 can store the collected tracking data on data store 514.

The SDK module 521 can enable a developer to provide applications via an application provider device 409a-409m that when installed on a UE 401a-401n can control presentation of or interaction with one or more websites accessed by the UE 401a-401n in relation with the application A. The SDK module 521 may also enable a developer to provide applications via an application provider device 409a-409m that when installed on a UE 401a-401n can provide dynamic access points to the application A on the UE 401a-401n. For example, a dynamic access point can be a graphic image (e.g., an icon), a picture or an object that provides a link to the application; a dynamic access point can be an access point (e.g., an icon) having features such as shape, color, location, etc. that can change based on information such as user profile, user's usage pattern of the application A accessed via the dynamic access point, etc. Furthermore, the dynamic access point can provide a link to an embedded application store that enables the user to download new applications. The access control module 512 can enable the application A to control presentation of or interaction with a website on the UE 401a-401n, for example, through controlling access to the website by a user of the UE 401a-401n. The access control module 512 enables an application to control a destination (e.g., a website) accessed by a UE 401a-401n in relation with the application A. Any of the modules 510, 512, 521 can store input, output or process data on their local memory spaces, or on the data store 514. Examples of the process of providing dynamic access points by the provisioning platform 503 within a communication network system, such as the communication network system 400 of FIG. 4, are further described below in connection with the flowchart of FIG. 6.

FIG. 6 is a flowchart of a process for providing dynamic access points via applications associated with a non-embedded provisioning platform, according to an embodiment. FIG. 6 is described with reference to the provisioning platform of FIG. 5 and the components of network communications system 400 of FIG. 4. Note that a UE 401a-401n can be used by an application developer user for providing applications that are offered to users of UEs 401a-401n by the application provider devices 409a-409n. Alternatively/additionally, a UE 401a-401n can be used by a user for accessing and using applications developed by the developer and offered by the application provider devices 409a-409n.

At 630, an application provider device 409 receives a request from an application developer using an application developer device 419, via the input signal 516, to download a Software Development Kit (SDK). A SDK is a set of software development tools that allows for the development of applications for a certain software package, software framework, hardware platform of UEs 401a-401n, application developer devices 419, etc. The SDK may be stored locally at a memory of the application developer device 419 or the application provider device 409, at a remote storage location accessible by the application developer device 419 and by the application provider device 409a-409m, or at the data store 514.

In some instances, the provisioning platform 503 enables the developer to provide embedded information or explanations to the users of the application about features that are added to the application (e.g., icons, usage tracking, etc.). Each selection and entry by the developer is represented by a signal received by the provisioning platform 503. The applications added by the developer and their associated data such as, for example, the number of application downloads by users, can be collected by the provisioning platform 503 and stored locally at a memory of the application provider device 409, at a remote storage location accessible by the application provider device 409, or at the data store 514, by the provisioning platform 503.

At 632, the application provider device 409 sends a SDK to the application developer device 419 via an output signal 518 of the provisioning platform 503 at the application provider device 409. The SDK can be used by the application developer device 419 to develop an application P1 (e.g., a provisioning platform or access application as described herein). The application P1 can then be provided by the application developer device 419 to one or more UEs 401. The application P1 can include, for example, the access control module 512, the usage tracking module 510, the data store 514 and the SDK module described above with reference to FIG. 5. The application P1 can include code C1 configured by the SDK, to enable the application P1 to control presentation of or interaction with a website on a UE 401a-401n such that the application P1 developed using the SDK at the application developer device 419 and provided to a user of UE 401a-401n by the application developer device, is installed on the UE 401a-401n. The SDK may also include code C2 that enables the application P1 to provide dynamic access points on a display of the UEs 401a-401n. The code C1 or C2 may be included in the application P1 at the time of development and installed on the UE 401a-401n with the application P1. Alternatively, the code C1 or C2 can be maintained at the application developer device 419 and interact with the application P1 and the UE 401a-401n via the communication network 405.

If, at 634, the application P1 is launched on the UE 401a-401n, then at 636, the provisioning platform developed by the SDK at the application developer device 419 sends a command to the UE 401a-401n via an output signal 518 to activate a code C3. The code C3 is configured to cause the access control module 512 to control presentation of or interaction with a website on UE 401a-401n. For example, the code C3 can be configured to enable the application P1 to control presentation of or interaction with a search engine on the UE 401a-401n where controlling presentation of or interaction with the search engine enables the usage tracking module 510 to track usage of the search engine by the UE 401a-401n via application P1. For example, the application P1 can collect data related to presentation of or interaction with a website accessed on UE 401a-401n via application P1. The collected data can be, for example, the number of interactions during a given period of time, the duration of each interaction, a user profile (including location, age, interests, etc.), etc. The access control module 512 can send the collected data to the provisioning platform 503 at the application developer device 419 via the communication network 405 and the usage tracking module 510 at the application developer device 419 can analyze the received data for determining usage patterns of the website by the UE 401a-401n. Furthermore, the application P1 can use the data collected by the access control module 512 to control a selected destination (e.g., a selected website address) by a user of the UE 401a-401n.

At 638, the access control module 512 provides a shortcut to the selected destination on the UE 401a-401n, when at least one of the dynamic access points provided by the application P1 on the UE 401a-401n is selected by a user of the UE 401a-401n. The shortcut enables UE 401a-401n to provide access to a user when the user selects the at least one dynamic access point.

Furthermore, the usage tracking data collected by the usage tracking module 510 may be stored at data store 514. The usage tracking data can be used for monetization purposes such that, for example, a developer of application P1 can receive revenues based on the usage of the provided destinations by the UE 401a-401n via application P1.

In some embodiments, an application developer can open an account associated with the provisioning platform 503 and register their developed applications through the account. In some embodiments, an application developer can select a desired type of icon integration to be used as dynamic access points on a UE 401a-401n at the time of application download. For example, the provisioning platform 503 can provide home screen icons, bookmark links, browser homepages, etc. on a UE 401a-401n that downloads an application. The icons selected by the developer can be configured by the SDK and the dynamic access points are provided via the application P1. Each selection and entry by the developer is represented by a signal received by the provisioning platform 503. Later, at the time of application download by a user, the configured dynamic access points are used by the provisioning platform 503 for displaying dynamic icons on a UI 407a-407n of a UE 401a-401n associated with the user.

After an application is registered by the developer at the provisioning platform 503, the provisioning platform 503 can provide integrated dynamic access points (e.g., dynamic icons) to UIs 407a-407n associated with downloading UEs 401a-401n, as described with regards to FIG. 6. The provisioning platform 503 can also track downloads of the application at the UEs 401a-401n and collect and store download and usage data, for example, in a local memory of the application provider device 409a-409m (not shown), at a remote storage location accessible by the application provider device 409a-409m, or in the data store 514. This collected and stored data can be used by the provisioning platform 503 for providing information to the application developer.

The provisioning platform 503 can provide payment information to the developer based on the information entered by the developer and collected by the provisioning platform 503 from the application provider device 409a-409m. The provisioning platform 503 can store the collected information at a local memory of the application provider device 409a-409m (not shown), at a remote storage location accessible by the application provider device 409a-409m, or at the data store 514. Alternatively, or in addition to, as discussed above with reference to FIG. 4, the developer device 419 can include a development management platform included within the provisioning platform 403, which can collect and store the information at a local memory of the developer's device 419.

FIG. 7 illustrates another method of providing a software development kit for developing an access application (or provisioning platform), according to another embodiment. In this embodiment, a software development kit can be provided to an electronic device (e.g., UE 101, 201, 401), which can be used to build or develop an access application (i.e., provisioning platform) at the electronic device. The method includes at 740, receiving from an electronic device (e.g., UE 101, 201, 401) a request to download a software development kit. For example, the request can be sent to an application provider device (e.g., 109, 209, 409) described herein. The application provider device can include a provisioning platform (e.g., 103, 203, 403) as described herein. The software development kit can include (1) code to control display of content on the electronic device when an application developed by the software development kit is installed on the electronic device, and (2) code to provide a dynamic access point on a display of the electronic device such that, when selected by a user of the electronic device, the dynamic access point provides access to the content including at least a website, an application previously downloaded on the electronic device, and/or an application store within the application. The application developed by the software development kit can be a provisioning platform or access application as described herein.

In some embodiments, the application developed by the software development kit includes an access control module and the access control module can be configured to provide access to the website, an application previously downloaded on the electronic device and/or the application store within the access application. In some embodiments, the application store within the application enables a user to download at least one application listed within the application store.

At 742, the software development kit is sent to the electronic device in response to the request to download. At 744, after sending the software development kit to the electronic device, a command to activate the application developed by the software development kit is sent to the electronic device. At 746, data is received that is associated with usage of a content accessed by the electronic device via the dynamic access point.

In some embodiments, the application developed by the software development kit is configured to change an appearance of the dynamic access point on the display of the electronic display. For example, in some embodiments, the application developed by the software development kit is configured to change an appearance of the dynamic access point on the display of the electronic display based on received information associated with the electronic device. For example, the received information can be associated with a user profile and/or a user's usage pattern of the code. In some embodiments, the application developed by the software development kit includes a usage tracking module configured to monitor a usage pattern of a user of the electronic device and store the usage pattern within the data store.

It is intended that the systems and methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein.

In one embodiment, a method comprises receiving a request from a first electronic device to download an application. The method further comprises sending a code to the electronic device. The code is configured to control displaying content of a website on the electronic device such that the application is installed on the electronic device. The code also includes code to provide access points to the application.

In some embodiments, the method further comprises sending a command to activate a code configured to cause the electronic device to enable the application to control a selected destination on the electronic device. The method further comprises providing a shortcut to the selected destination on the electronic device, when at least one of the access points is selected by a user of the electronic device.

In some embodiments, a method comprises receiving a request from a first electronic device to download a software development kit. The method further comprises sending the software development kit to the first electronic device. The software development kit includes code configured to control display of content of a website on a second electronic device such that an application developed using the software development kit is installed on the second electronic device. The software development kit also includes code to provide access points to the application.

In some embodiments, the method further comprises sending a command to activate a code configured to cause the second electronic device to enable the application to control a selected destination on the second electronic device. The method further comprises providing a shortcut to the selected destination on the second electronic device, when at least one of the access points is selected by a user of the second electronic device.

What is claimed is:

1. A method, comprising:
receiving from an electronic device a request to download an access application; and
sending a code to the electronic device, the code configured to cause the access application to be installed on the electronic device, the access application configured provide a dynamic access point on a display of the electronic device,
when selected by a user of the electronic device, the dynamic access point provides access to at least one of a website, an application previously downloaded on the electronic device, or an application store within the access application.

2. The method of claim 1, further comprising:
sending to the electronic device, after sending the code, a command to activate the code to enable the access application to control the dynamic access point on the electronic device.

3. The method of claim 1, wherein the access application is configured to change an appearance of the dynamic access point on the display of the electronic display.

4. The method of claim 1, wherein the access application is configured to change an appearance of the dynamic access point on the display of the electronic display based on received information associated with the electronic device, the received information being associated with at least one of a user profile or a user's usage pattern of the access application.

5. The method of claim 1, wherein the application store within the access application enables a user to download at least one application listed within the application store.

6. The method of claim 1, wherein the access application includes an access control module, the access control module being configured to provide access to the at least one of a website, an application previously downloaded on the electronic device or an application store within the access application.

7. The method of claim 1, wherein the access application includes a usage tracking module configured to monitor a usage pattern of a user of the electronic device and store the usage pattern within the data store.

8. A method, comprising:
sending, to a compute device from an electronic device, a request for an access application; and
receiving at the electronic device from the server, a code configured to cause the access application program to be installed on the electronic device, the access application configured provide a dynamic access point on a display of the electronic device,
when selected by a user of the electronic device, the dynamic access point provides access to at least one of a website, an application previously downloaded on the electronic device, or an application store within the access application.

9. The method of claim 8, further comprising:
receiving, at the electronic device from the compute device, after receiving the code, a command to activate the code to enable the access application to control the dynamic access point icon on the electronic device.

10. The method of claim 8, wherein the access application is configured to change an appearance of the dynamic access icon on the display of the electronic display.

11. The method of claim 8, wherein the access application is configured to change an appearance of the dynamic access icon on the display of the electronic display based on received information associated with the electronic device, the received information being associated with at least one of a user profile or a user's usage pattern of the access application.

12. The method of claim 8, wherein the application store within the access application enables a user to download at least one application listed within the application store.

13. The method of claim 8, wherein the access application includes an access control module, the access control module being configured to provide access to the at least one of a website, an application previously downloaded on the electronic device or an application store within the access application.

14. The method of claim 8, wherein the access application includes a usage tracking module configured to monitor a usage pattern of a user of the electronic device and store the usage pattern within the data store.

15. A method, comprising:
receiving from an electronic device a request to download a software development kit, the software development kit including (1) code to control display of content on the electronic device when an application developed by the software development kit is installed on the electronic device, and (2) code to provide a dynamic access point on a display of the electronic device such that, when selected by a user of the electronic device, the dynamic access point provides access to the content including at least one of a website, an application previously downloaded on the electronic device, or an application store within the application; and
sending, to the electronic device, the software development kit in response to the request to download.

16. The method of claim 15, further comprising:
sending to the electronic device, after sending the software development kit, a command to activate the application developed by the software development kit.

17. The method of claim 15, wherein the application developed by the software development kit is configured to change an appearance of the dynamic access point on the display of the electronic display.

18. The method of claim 15, wherein the application developed by the software development kit is configured to change an appearance of the dynamic access point on the display of the electronic display based on received information associated with the electronic device, the received information being associated with at least one of a user profile or a user's usage pattern of the code.

19. The method of claim 15, wherein the application store within the application enables a user to download at least one application listed within the application store.

20. The method of claim 15, wherein the application developed by the software development kit includes an access control module, the access control module being configured to provide access to the at least one of a website, an application previously downloaded on the electronic device or an application store within the access application.

21. The method of claim 15, wherein the application developed by the software development kit includes a usage tracking module configured to monitor a usage pattern of a user of the electronic device and store the usage pattern within the data store.
